(19) United States
(12) Patent Application Publication
(10) Pub. No.: US 2014/0349069 A1
(43) Pub. Date: Nov. 27, 2014

(54) Thermoplastic Material Having a Surface Texture That Promotes Adherence of Inks and Other Materials, and Related Systems and Methods

(71) Applicant: MicroGREEN Polymers, Inc., Arlington, WA (US)

(72) Inventors: Krishna Nadella, Redmond, WA (US); Shawna Laramore, Lake Stevens, WA (US)

(21) Appl. No.: 14/371,976

(22) PCT Filed: Jan. 14, 2013
(86) PCT No.: PCT/US13/21483

§ 371 Date: Jul. 11, 2014

Related U.S. Application Data
(60) Provisional application No. 61/585,974, filed on Jan. 12, 2012.

(51) Int. Cl. B41M 5/50; B29C 44/34

(52) U.S. Cl. CPC B41M 5/502; B29C 44/3403; B29C 44/348
USPC 428/141; 264/51

(57) ABSTRACT

A thermoplastic material having a thickness includes a polymer having a microstructure that includes a plurality of closed cells disposed in an inner region of the material's thickness. Each of the plurality of closed cells contains a void and each of the cells has a maximum dimension extending across the void within the cell that ranges between 1 micrometer and 500 micrometers long. The thermoplastic material also includes a substantially solid skin disposed in an outer region of the material's thickness. The skin includes a surface having a surface energy and a texture that increases the surface energy to more than 38 dynes per square centimeter.

### CROSS REFERENCE TO RELATED APPLICATION AND CLAIM OF PRIORITY

This application claims priority from commonly owned U.S. Provisional Patent Application 61/585,974 filed 12 Jan. 2012, and titled “Microcellular Thermoplastic Substrate With Controllable Inherent Surface Energy And Method For Making The Same”, presently pending, which is incorporated by reference.

### BACKGROUND

More and more, plastic material is being used in applications in which paper was previously preferred. For example, plastics are now often used to package and contain goods as well as provide a medium on which information is displayed, such as a sign. In many of these applications, printing text or an image on the plastic material to convey information, such as a company's brand or a description of the goods contained in a package or advertised via a sign, is desirable. Unfortunately, though, printing on plastic material is more difficult that printing on paper because the surface energy of the plastic material's surface is often too low to hold and retain conventional inks in the desired pattern. Often the inks slide across and/or off the plastic material's surface, making the desired text and/or image unreadable, unattractive, inaccurate and/or deceptive.

Surface energy is a measure of a surface's willingness to hold onto or adhere to another surface. When a drop of ink is placed on a surface, the molecules of ink in the drop attract and hold onto each other (cohesion) to form a bead. This cohesion causes tension in the surface of the ink drop—i.e. surface tension of the ink. When the surface energy of the surface that the ink is on exceeds the surface tension of the ink, the drop of ink will flatten out onto the surface, not bead up; and thus, the ink is more firmly held to the surface.

For paper, the surface energy typically far exceeds the surface tension of most inks, and thus paper is typically easy to print on. For most conventional plastic materials, though, the surface energy is typically less than the surface tension of most inks, and thus most conventional plastic materials are difficult to print on.

A common way to improve a plastic material's surface energy, and thus its printability, is to treat the material's surface to increase the surface's surface energy. Typically, such a treatment involves exposing the surface to a plasma—ionized molecules that contain charged particles in the form of positive ions and negative electrons. The charged particles react with the molecules forming the surface of the material to form more reactive functional groups in the molecules and thus increase the surface energy of the material's surface. When the plasma is generated by an electric spark the treatment is referred to as corona treatment. When the plasma is generated by a flame it is referred to as flame treatment. Other treatments include chemically altering the surface of the plastic material by oxidation and/or polymer-chain splitting.

There are, however, problems with such surface treatments. The increase in surface energy is often not stable and not long-lasting. The increase in surface energy degrades, eventually rendering the plastic material's surface unsuitable for printing. In many of these cases, another such treatment needs to be applied to the plastic material's surface to improve the surface's printability. Thus, the cost for printing on such plastic materials increases.

Another way to improve a plastic material's surface energy, and thus its printability, is to formulate a specialty ink designed to react with the specific plastic material. In this manner, the surface energy of the specific plastic material may be high when paired with the specialty ink, but remain low for most conventional inks. This, too, has problems because the cost to develop and produce such specialty inks is great.

### SUMMARY

In an aspect of the invention, a thermoplastic material having a thickness includes a polymer having a microstructure that includes a plurality of closed cells disposed in an inner region of the material's thickness. Each of the closed cells of the plurality of closed cells contains a void and each of the cells has a maximum dimension extending across the void within the cell that ranges between 1 micrometer and 500 micrometers long. The thermoplastic material also includes a substantially solid skin disposed in an outer region of the material's thickness. The skin includes a surface having a surface energy and a texture that increases the surface energy to more than 38 dynes per square centimeter.

By combining a substantially solid skin with a plurality of closed cells underneath the skin, the texture of the exterior surface of the skin can be made rougher than the texture of the exterior surface of a solid material (material without the closed cells). By increasing the roughness of the skin's exterior surface, one can increase the surface energy of the skin's exterior surface, and thus make the thermoplastic material more printable, i.e. better able to hold and retain conventional inks.

In another aspect of the invention, a method for generating a thermoplastic material that includes a surface having a surface energy greater than 38 dynes per square centimeter is provided. The method includes: a) exposing the material to an atmosphere of a gas pressurized to saturate an inner region and an outer region of the material with the gas, b) reducing the pressure of the gas in the atmosphere to cause an outer region of the material to desorb absorbed gas, c) nucleating cells to generate a plurality of cells in the material's inner region. Nucleating cells in the material includes reducing the pressure of the gas atmosphere to cause the material to become supersaturated, and heating the material to at least a glass-transition temperature of the supersaturated material, or near the glass-transition temperature. The method for generating the thermoplastic material also includes holding the temperature of the material for a period of time to allow the cells to grow in size, and reducing the temperature of the material to stop the growth in size of the cells when 1) the size of each of the plurality of cells reaches between 1 and 500 micrometers long in a maximum dimension extending across a void within each cell, and 2) a surface energy of a surface of a substantially solid skin disposed in an outer region of the material's thickness reaches at least 38 dynes per square centimeter.

By controlling parameters of the process, such as the temperature and gas pressure and exposure duration during saturation of the material, the gas pressure and duration during desorption of the outer region, and the amount and duration of the heat during cell growth, one can control the thickness of the solid skin and the sizes of the plurality of closed cells. Thus one can tune the roughness of the skin to make a thermoplastic material whose exterior surface has any desired surface energy.

### BRIEF DESCRIPTION OF THE FIGURES

FIG. 1 is a photograph of a cross-section of a portion of a thermoplastic material that includes a surface having a surface energy greater than 38 dynes per square centimeter, according to an embodiment of the invention. The photograph shows the cross-section at a magnification of 100 times its actual size.

FIG. 2 is a photograph of a portion of the cross-section shown in FIG. 1. The photograph shows the portion of the cross-section at a magnification of 500 times its actual size.

FIG. 3 is a cross-sectional view of a thermoplastic material that includes ink printed on the material's surface, according to an embodiment of the invention.

FIG. 4 is a perspective view of a material, according to another embodiment of the invention.

FIG. 5 is a perspective view of a material, according to yet another embodiment of the invention.

FIG. 6 is a perspective view of a portion of the material shown in FIG. 5.

FIGS. 7 and 8 are schematic views of a process for generating a thermoplastic material that includes a surface having a surface energy greater than 38 dynes per centimeter, according to an embodiment of the invention.

### DETAILED DESCRIPTION

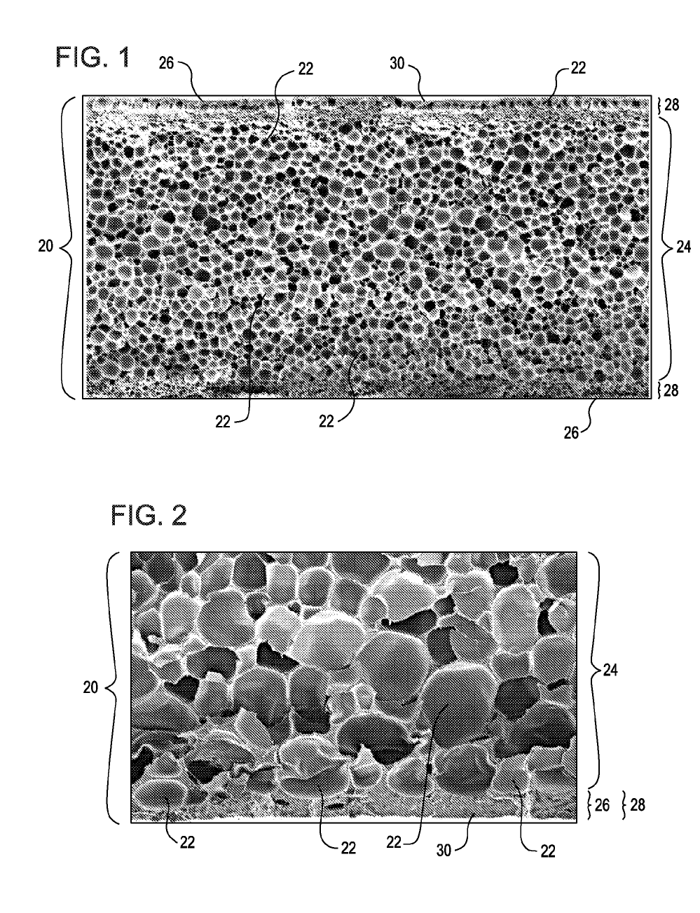

FIGS. 1 and 2 are photographs of a cross-section of a portion of a thermoplastic material 20, according to an embodiment of the invention. The thermoplastic material 20 has a microstructure that includes a plurality of closed cells 22 (only four labeled in FIG. 1 for clarity) disposed in an inner region 24 of the material's thickness, and a substantially solid skin 26 disposed in an outer region 28 of the material's thickness. The skin 26 includes a surface 30 having a texture that increases the surface's surface-energy to at least 38 dynes per square centimeter. By increasing the surface energy of the skin's surface 30, the thermoplastic material more easily holds and retains conventional inks, and thus makes the thermoplastic material more printable.

The roughness of the skin's surface 30 affects the surface energy of the surface 30. As the roughness of the texture increases, the surface energy of the skin's surface 30 increases. The roughness of the skin's surface 30 is affected by the skin's thickness and the size of many of the closed cells 22 in the inner region 24. Because some of the closed cells 22 lie directly underneath the skin 26, these closed cells 22 deform the skin 26, and thus, deform the surface 30 of the skin 26. This deformation in the skin's surface 30 roughens the surface 30, which promotes fluidic anchoring, and improves interfacial diffusion for bonding with ink.

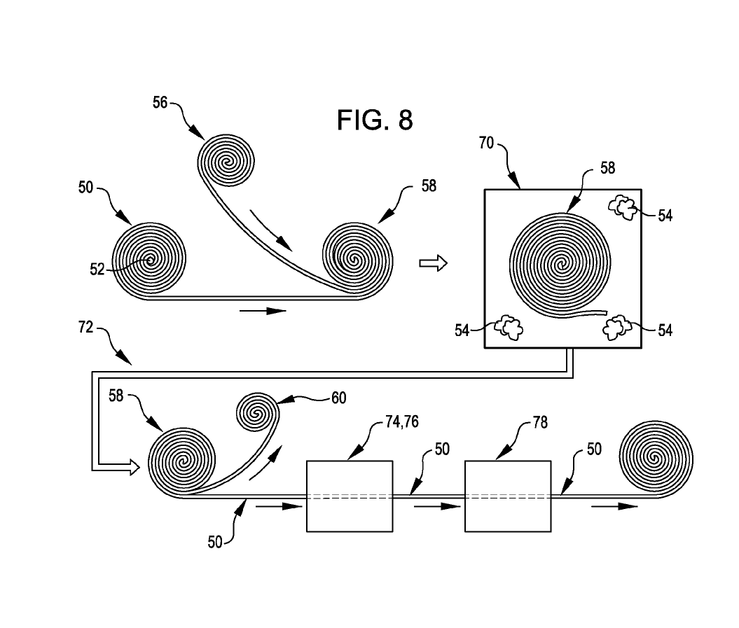

As discussed in greater detail in conjunction with FIGS. 7 and 8, a method for forming the skin 26 and the plurality of closed cells 22 in the thermoplastic material 20 includes saturating a thermoplastic material with a gas, allowing a portion of the material to desorb some or all of the gas; heating the material to nucleate and grow closed cells, and reducing the temperature of the material to stop the growth of the cells. By modifying parameters of this method, one can modify the thickness of the skin 30 and the size of the cells 22 in the thermoplastic material's microstructure, and thus modify, as desired, the roughness of the skin's surface 30. By modifying the roughness of the skin's surface 30 one can modify the surface energy of the skin's surface 30, as desired, to hold and retain conventional inks, thus making the thermoplastic material 20 more printable. And, because this method does not include exposing the skin's surface 30 to a plasma, or chemically altering the skin's surface 30 by oxidation and/or polymer-chain splitting, the surface energy of the skin's surface 30 will not fade over time.

Referring to FIG. 2, the roughness of the skin's surface 30 may be any desired roughness capable of increasing the surface energy of the skin's surface. For example, in this and other embodiments of the thermoplastic material 20, the surface 30 may have a roughness between 100 to 250 Sheffield units, or standard cubic centimeters. The Sheffield method for determining surface roughness measures the amount of air that passes between a measuring head and the surface under specific conditions. In operation, the measuring head is placed on the surface to be measured, and air is pumped into the head. Because the surface that the measuring head contacts is rough, the measuring head does not make an air-tight seal with the surface. As air is pumped into the measuring head some of the air escapes between the measuring head and the surface. The amount of air that escapes during a specific period of time with a specific air pressure in the measuring head, indicates the roughness of the surface. The more air that escapes, the rougher the surface. For polyethylene terephthalate (PET) a roughness between 100 to 250 Sheffield units translates into a surface energy of between 40 and 45 dynes per square centimeter.

The thermoplastic material 20 may include any desired thermoplastic material. For example, in this and other embodiments, the thermoplastic material 20 includes polyethylene terephthalate (PET). In other embodiments the thermoplastic material 20 may include at least one of the following: polystyrene, polycarbonate, acrylonitrile-butadiene-styrene, glycol modified PET, polyethylene, polypropylene, NORYL (a blend of polyphenylene oxide and polystyrene), and polyvinyl chloride.

Still referring to FIGS. 1 and 2, the microstructure of the thermoplastic material 20 may be configured as desired to provide a desired roughness in the skin's surface 30. For example, in this and other embodiments, the inner region 24 may include a substantially uniform distribution of closed cells 22 ranging in size from 10 to 50 micrometers, and the outer region 28 may include a skin 26 whose thickness ranges from 5 to 25 micrometers. The size of each cell 22 is determined by the maximum dimension extending across the void that each cell contains. In addition, the skin 26 may be integral to the plurality of closed cells 22. More specifically, the skin 26 and plurality of closed cells 22 may be formed during a single process, such as that shown and discussed in conjunction with FIGS. 7 and 8, and from the same initial sheet of solid thermoplastic material. In other examples, the size of the closed cells 22 may range from 1 to 500 micrometers, and the distribution of the cells may not be substantially uniform—e.g. the inner region 24 may include two or more layers of cells 22 whose sizes are substantially uniform within the layer but whose sizes are different than the sizes of the cells 22 in other layers. In addition, the skin 26 may not be integral to the closed cells 22, but formed after the closed cells 22 have been formed.

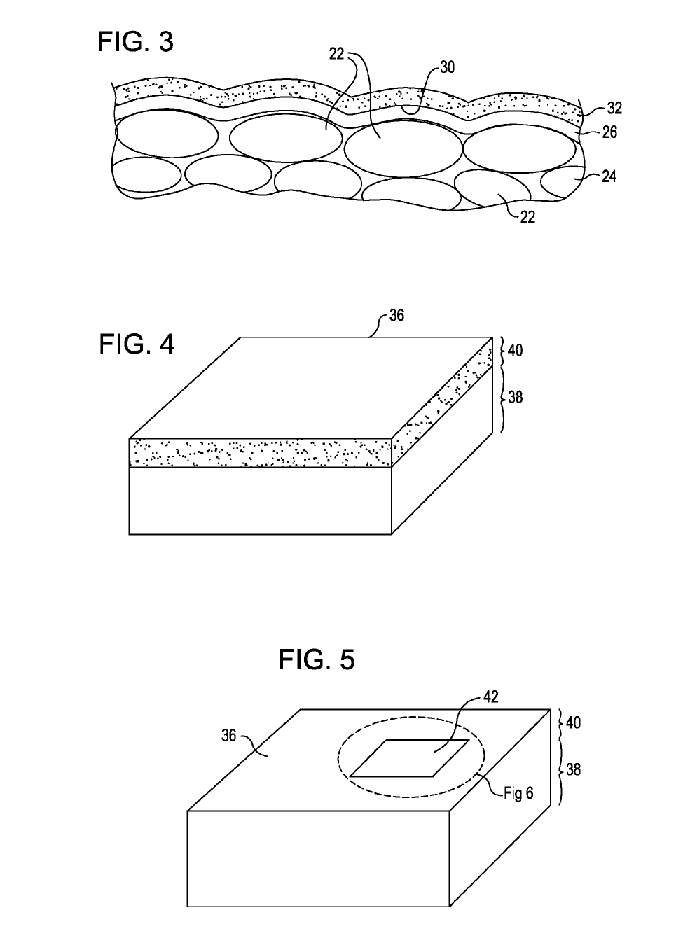

FIG. 3 is a cross-sectional view of a thermoplastic material that includes ink 32 printed on the material's surface, according to an embodiment of the invention. The ink 32 may be any desired conventional ink and may be printed onto the surface 30 of the skin 26 in any desired pattern. For example, in this and other embodiments the pattern may form a visual image, such as a copy of a face or trademark. In other embodiments, the pattern may form text that a person can read. In still other embodiments the pattern may form both a visual image and text.

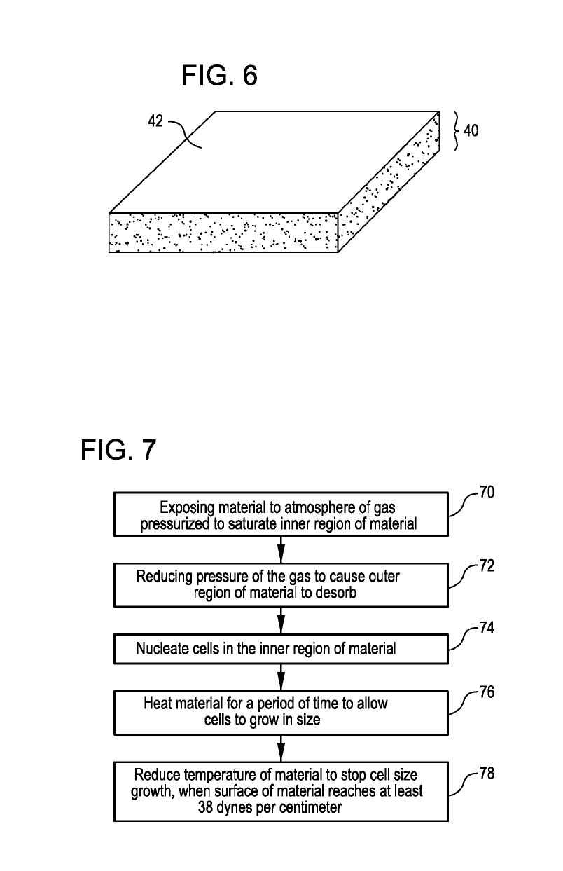

FIGS. 4, 5 and 6 are perspective views of a material 36, according to other embodiments of the invention. The material 36 includes an interior 38 and an exterior 40. The interior 38 may include any desired material, thermoplastic or not, and the exterior 40 may include any desired thermoplastic material having a microstructure similar to the microstructure discussed in conjunction with FIGS. 1-3. The material 36 shown in FIG. 4 includes an exterior 40 having the microstructure throughout the whole exterior 40. And, the material 36 shown in FIG. 5 includes an exterior 40 having the microstructure in a portion or region 42 of the exterior 40. FIG. 6 shows the portion or region 42 of the exterior 40 that includes the microstructure discussed in conjunction with FIGS. 1-3. As discussed in greater detail in conjunction with FIGS. 7 and 8, a method for forming the microstructure in the exterior 40 of each of the materials 36 includes saturating the exterior 40 or a portion or region 42 of the exterior 40 with a gas, allowing some of the exterior 40 or some of the portion or region 42 of the exterior 40 to desorb some or all of the gas; heating the exterior 40 or portion or region 42 material to nucleate and grow closed cells, and reducing the temperature of the exterior 40 or portion or region 42 to stop the growth of the cells.

FIGS. 7 and 8 are schematic views of a process for generating the thermoplastic material 20 (FIGS. 1-3) that includes a surface 30 (FIGS. 1-3) having a surface energy greater than 38 dynes per square centimeter, according to an embodiment of the invention. As previously mentioned, the thermoplastic material 20 includes a skin 26 (FIGS. 1-3) in the outer region 28 (FIGS. 1-3), that is integral to the closed cells 22 (FIGS. 1-3) in the inner region 24 (FIGS. 1-3) of the material. More specifically, the skin 26 and closed cells 22 are formed during a single process, such as that shown and discussed in conjunction with FIGS. 7 and 8, and from the same initial sheet of solid thermoplastic material.

In this and other embodiments, a process for generating a microstructure that includes a skin 26 (FIGS. 1-3) and a plurality of closed cells 22 (FIGS. 1-3) in a thermoplastic material includes dissolving into the material 50 (here shown as a film rolled around a drum 52, but may be a block or thin sheet) a gas 54 that does not react with the material 50. The process also includes heating the material 50 with the dissolved gas at a temperature that is, is close to, or above the glass-transition temperature of the material and dissolved gas combination. The glass-transition temperature is the temperature at which the material 50 is easily malleable but has not yet melted. With the temperature at, near, or above the glass-transition temperature, bubbles of the gas 54 can nucleate and grow in regions of the material 50 that are thermodynamically unstable—i.e. supersaturated. When the bubbles have grown to a desired size, the temperature of the material 50 is reduced below the glass-transition temperature to stop the bubbles' growth, and thus provide the material 50 with a microstructure having closed-cells whose size may range between 1 and 500 micrometers long.

In the process, the first step 70 is to dissolve into the material 50 any desired gas 54 that does not react with the material 50. For example, in this and certain other embodiments of the process, the gas 54 may be carbon dioxide (CO₂) because CO₂ is abundant, inexpensive, and does not react with PET. In other embodiments of the process, the gas may be nitrogen and/or helium. Dissolving the gas 54 into the material 50 may be accomplished by exposing the material for a period of time to an atmosphere of the gas 54 having a temperature and a pressure. The temperature, pressure, and period of time may be any desired temperature, pressure, and period of time to dissolve the desired amount of gas 54 into the material 50. The amount of gas 54 dissolved into the material 50 is directly proportional to the pressure of the gas 54 and the period of time that the material 50 is exposed to the gas 54 at a specific temperature and specific pressure, but is inversely proportional to the temperature of the gas 54. For example, in this and certain other embodiments, the temperature may be 72° Fahrenheit, the pressure may be 725 pounds per square inch (psi), and the duration of the period may be 10 hours. This typically saturates the material 50 with the gas 54. In other embodiments, the pressure may range between 500 psi and 1000 psi, and the duration of the period may range between 4 hours and 48 hours.

Because the layers of the rolled material film 50 that lie between adjacent layers or between a layer and the drum 52 are substantially unexposed to the atmosphere when the roll is placed in the atmosphere, a material 56 is interleaved between each layer of the rolled material film that exposes each layer to the atmosphere. In this and certain other embodiments, the material 56 includes a sheet of cellulose, and is disposed between each layer of the material film 50 by merging the sheet with the film and then rolling the combination into a single roll 58. The material 56 exposes each layer of the material film 50 by allowing the gas 54 to easily pass through it. After the gas 54 has saturated the material film 50, the material 56 may be removed from the roll 58 and saved as a roll 60 for re-use.

The next step 72 in the process includes exposing the material film 50 with the dissolved gas 54 to an atmosphere having less pressure than the one in the first step to cause the combination of the material film 50 and the gas 54 dissolved in the material film 50 to become thermodynamically unstable—i.e. the whole material or regions of the material to become supersaturated with the dissolved gas 54. For example, in this and certain other embodiments, the reduction in pressure may be accomplished by simply exposing the material film 50 to atmospheric pressure, which is about 14.7 psi, in the ambient environment.

When the combination of the material film 50 and the dissolved gas 54 becomes thermodynamically unstable, the dissolved gas tries to migrate out of the film 50 and into the ambient environment surrounding the film 50. Because the dissolved gas in the interior regions of the material film 50 must migrate through the regions of the material film 50 that are closer to the film's surface to escape from the material film 50, the dissolved gas in the interior regions begins to migrate after the dissolved gas in the surface regions begins to migrate, and takes more time to reach the ambient environment surrounding the material film 50 than the dissolved gas 54 in the film's regions that is closer to the film's surface. Thus, before heating the material film 50 to a temperature that is, is close to or above its glass-transition temperature, one can modify the concentration of dissolved gas 54 in regions of the material film 50 by exposing for a period of time the material film 50 to an atmosphere having less pressure than the one in the first step. Because the concentration of dissolved gas 54 depends on the amount of gas that escapes into the ambient environment surrounding the material film 50, the concentration of dissolved gas 54 is inversely proportional to the period of time that the film 50 is exposed to the low-pressure atmosphere before being heated to, close to, or above its glass-transition temperature.

In this manner, a skin, such as the skin 26 (FIGS. 1-3), may be formed in the material film 50 when the film 50 is heated to a temperature that is, is close to or above its glass-transition temperature. For example, in this and certain other embodiments, the roll 58 of material film and interleaved material 56 can remain in a thermodynamically unstable state for a period of time before removing the material 56 from the roll 58 and heating the film. This allows some of the gas dissolved in the region of the film adjacent the film's surface to escape. With the gas absent from this region of the film, this region becomes more thermodynamically stable than the regions that are further away from the film's surface. With a sufficient amount of thermodynamic stability in the region, bubbles won't nucleate in the region when the film is heated to, close to, or above its glass-transition temperature. Consequently, closed cells 22 (FIGS. 1-3) can be omitted from this region of the film, leaving a solid portion of the microstructure that is integral to the closed cell portion of the microstructure, such as the skin 26 (FIGS. 1-3). Because the thickness of the skin 26 or solid portion depends on the absence of dissolved gas 54 in the region of the film 50, the thickness of the skin 26 or solid portion is directly proportional to the period of time that the film 50 spends in a thermodynamically unstable state before being heated to, close to, or above its glass-transition temperature. In this and certain other embodiments, the thickness of the integral skin ranges 5-100 micrometers.

The next steps 74 and 76 in the process are to nucleate and then grow bubbles in the material 50 to achieve a desired relative density for the material film 50. The relative density is the density of the material film 50 with the closed cells divided by the density of the material 50 without the closed cells. Bubble nucleation and growth begin about when the temperature of the material film 50 is or is close to the glass-transition temperature of the material film 50 with the dissolved gas 54. The duration and temperature at which bubbles are nucleated and grown in the material 50 may be any desired duration and temperature that provides the desired relative density. For example, in this and certain other embodiments, the temperature that the PET material 50 is heated to is approximately 200°-280° Fahrenheit, which is about 40°-120° warmer than the glass-transition temperature of the material without any dissolved gas 54. The PET film 50 is held at approximately 200°-280° Fahrenheit for approximately 30 seconds. This provides a relative density of the closed-cell film of about 18.5%. If the PET film 50 is held at 200°-280° Fahrenheit for a period longer than 30 seconds, such as 120 seconds, then the bubbles grow larger, and thus the size of resulting closed cells 22 (FIGS. 1-3) are larger. This may provide a relative density of the closed-cell film of about 10%-20%. If the PET film 50 is held at 200°-280° Fahrenheit for a period shorter than 30 seconds, such as 10 seconds, then the bubbles remain small, and thus the size of resulting closed cells 22 (FIGS. 1-3) are smaller. This may provide a relative density of the closed-cell film of about 40%.

To heat the material film 50 that includes the dissolved gas 54, one may use any desired heating apparatus. For example, in this and certain other embodiments, the PET film may be heated by a roll fed flotation/impingement oven, disclosed in the currently pending U.S. patent application Ser. No. 12/423,790, titled ROLL FED FLOTATION/IMPINGEMENT AIR OVENS AND RELATED THERMOFORMING SYSTEMS FOR CORRUGATION-FREE HEATING AND EXPANDING OF GAS IMPREGNATED THERMOPLASTIC WEBS, filed 14 Apr. 2009, and incorporated herein by this reference. This oven suspends and heats a material film that moves through the oven, without restricting the expansion of the film.

The next step 78 in the process includes reducing the temperature of the heated material 50, and thus the malleability of the material 50 that occurs at, near, or above the glass-transition temperature, to stop the growth of the bubbles. The temperature of the heated material may be reduced using any desired technique. For example, in this and certain other embodiments, the material film 50 may be left to cool at ambient room temperature—i.e. simply removed from the heating apparatus. In other embodiments the heated material film 50 may be quenched by drenching it with cold water, cold air, or any other desired medium.

Other embodiments of the process are possible. For example, the material film 50 can be heated to a temperature that is or is close to its glass-transition temperature when the material film 50 is initially exposed to an atmosphere that causes the gas dissolved in the material film 50 to become thermodynamically unstable. This allows one to make a film that includes a skin having a minimal thickness.

By modifying parameters of the process, one can modify the thickness of the skin 30 (FIGS. 1-3) and the size of the cells 22 (FIGS. 1-3) in the thermoplastic material's microstructure, and thus modify, as desired, the roughness of the skin's surface 30 (FIGS. 1-3). For example, increasing the gas pressure during the saturation step 70 typically decreases the roughness of the skin's surface 30; and decreasing the gas pressure during the saturation step 70 typically increases the roughness of the skin's surface 30. Increasing the duration of the saturation step 70 typically decreases the roughness of the skin's surface 30; and decreasing the duration 70 typically increases the roughness of the skin's surface 30. Increasing the temperature of the saturation step 70 typically increases the roughness of the skin's surface 30; and decreasing the temperature of the saturation step 70 typically decreases the roughness of the skin's surface. Increasing the relative density of the thermoplastic material 50 typically decreases the roughness of the skin's surface 30; and decreasing the relative density of the thermoplastic material 50 typically increases the roughness of the skin's surface 30.

The preceding discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A thermoplastic material having a thickness, the material comprising:
a polymer having a microstructure that includes:
a plurality of closed cells disposed in an inner region of the material's thickness, each cell containing a void and each cell having a maximum dimension extending across the void within the cell that ranges between 1 micrometer and 500 micrometers long, and
a substantially solid skin disposed in an outer region of the material's thickness, wherein the skin includes a surface having:
a surface energy, and
a texture that increases the surface energy to at least 38 dynes per square centimeter.

2. The thermoplastic material of claim 1 wherein the polymer includes at least one of the following: polyethylene terephthalate (PET), polystyrene, polycarbonate, acrylonitrile-butadiene-styrene, glycol modified PET, polyethylene, polypropylene, NORYL (a blend of polyphenylene oxide and polystyrene), and polyvinyl chloride.

3. The thermoplastic material of claim 1 wherein each of the closed cells of the plurality of closed cells has a maximum dimension extending across the void within the cell that ranges between 10 micrometers and 50 micrometers long.

4. The thermoplastic material of claim 1 wherein the texture of the surface includes a roughness between 100 and 250 Sheffield units.

5. The thermoplastic material of claim 1 wherein the surface energy of the surface is between 40 and 45 dynes per square centimeter.

6. The thermoplastic material of claim 1 wherein:
the polymer includes PET, and
the surface energy of the surface is between 43 and 45 dynes per square centimeter.

7. The thermoplastic material of claim 1 wherein:
the polymer includes polyethylene terephthalate (PET), and the surface energy of the surface is between 38 and 55 dynes per square centimeter.

8. The thermoplastic material of claim 1 wherein the skin is integral to closed cells in the interior region.

9. The thermoplastic material of claim 1 wherein the skin has a thickness that ranges from 1 to 100 micrometers.

10. A printed thermoplastic material having a thickness, the printed material comprising:
a polymer having a microstructure that includes:
a plurality of closed cells disposed in an inner region of the material's thickness, each cell containing a void and each cell having a maximum dimension extending across the void within the cell that ranges between 1 micrometer and 500 micrometers long, and
a substantially solid skin disposed in an outer region of the material's thickness, wherein the skin includes a surface having:
a surface energy, and
a texture that increases the surface energy to at least 38 dynes per square centimeter; and
ink disposed in a pattern on the surface of the skin.

11. The printed material of claim 10 wherein the pattern forms text.

12. The printed material of claim 10 wherein the pattern forms a visual image.

13. A method for generating a thermoplastic material that includes a surface having a surface energy greater than 38 dynes per centimeter, the method comprising:
exposing the material to an atmosphere of a gas pressurized to saturate an inner region and an outer region of the material with the gas;
reducing the pressure of the gas in the atmosphere to cause an outer region of the material to desorb absorbed gas;
nucleating a plurality of cells in the material's inner region, by:
reducing the pressure of the gas atmosphere to cause the material to become supersaturated, and
heating the material to at least a glass-transition temperature of the supersaturated material, or near the glass-transition temperature;
holding the temperature of the material for a period of time to allow the cells to grow in size; and
reducing the temperature of the material to stop the growth in size of the cells, when the size of each of the plurality of cells reaches between 1 and 500 micrometers long in a maximum dimension extending across a void within each cell, and a surface energy of a surface of a substantially solid skin disposed in an outer region of the material's thickness reaches at least 38 dynes per square centimeter.

14. The method of claim 13 wherein the material is exposed to the atmosphere of gas for between 12 and 45 hours and the gas is pressurized between 500 psi and 1,000 psi.

15. The method of claim 13 wherein reducing the pressure of the gas in the atmosphere to cause an outer region of the material to desorb absorbed gas includes:
reducing the pressure of the gas to 0.1 MPa, and
exposing the material to the reduced-pressure atmosphere for between 1 minute and 7 days.

16. The method of claim 13 wherein heating the material includes heating the material to a temperature of about 165° Fahrenheit.
